(19) United States
(12) Patent Application Publication
(10) Pub. No.: US 2015/0301211 A1
(43) Pub. Date: Oct. 22, 2015

(54) METHOD AND DEVICE COMPENSATING FOR WATER VELOCITY VARIATION FOR 4D DATA SETS

(71) Applicant: CGG Services SA, Massy Cedex (FR)

(72) Inventors: Celine LACOMBE, Massy (FR); Henning HOEBER, East Grinstead (GB)

(73) Assignee: CGG Services SA, Massy Cedex (FR)

(21) Appl. No.: 14/256,376

(22) Filed: Apr. 18, 2014

(51) Int. Cl. G01V 1/30; G01V 1/38

(52) U.S. Cl. CPC G01V 1/308; G01V 1/38

(57) ABSTRACT

Methods for determining a seismic wave's propagation velocity in water for monitor seismic data of a 4D data set analyze a relationship between seafloor time-shifts and source-receiver offsets. The time-shifts are differences of normal move out corrected seafloor source-receiver travel times for pairs of traces. Each pair includes a base trace extracted from base seismic data of the 4D data set and a monitor trace extracted from the monitor seismic data, the traces corresponding to the same seafloor bin and having the same source-receiver offset.

### BACKGROUND

1. Technical Field

Embodiments of the subject matter disclosed herein generally relate to methods and devices used for seismic data processing of 4-dimensional (4D) data sets, more specifically, methods and devices configured to compensate for variations of the seismic wave's propagation velocity in water between different surveys.

2. Discussion of the Background

Seismic surveys are used to investigate underground formations by generating seismic waves and measuring reflected waves (travel time, amplitude, etc.). The travel time from the seismic wave's source to a reflecting interface and then to the seismic wave's receiver (i.e., detector) is dependent on the length of the traveled path and the velocity of the wave along that path. Seismic data acquired by receivers is processed and converted into structural information about the underground formation.

Time-lapse seismic surveying is increasingly used to monitor hydrocarbon-bearing underground reservoirs. In time-lapse seismic surveying, seismic data related to the same reservoir are acquired at least twice over a period of time (e.g., months or years) such that significant changes could have occurred in the underground formation between the respective seismic surveys. The time between seismic surveys is an additional data dimension besides the 3-dimensional (3D) spatial characteristics of conventional seismic data. Therefore, time-lapse seismic surveying is also referred to as 4D. Note that among 3D spatial characteristics, two are related to the horizontal position of a common mid-point (CMP), and a third one is related to depth that can be represented by a length coordinate or by a time coordinate (such as the two-way travel time of a seismic wave, from the surface to a certain depth and back). In a 4D data set that includes seismic data acquired during at least two seismic surveys, the earliest acquired data set is known as the “base data” and the other data set(s) is/are known as the “monitor(s) data.”

Ideally, the only differences observed between surveys would be due to changes in the reservoir related to hydrocarbon production. In fact, the observed differences are also due to acquisition and/or environmental changes between the two (or more) seismic surveys. To minimize the acquisition-related differences, the seismic data sets are acquired in a similar manner (e.g., repeating the source and receiver positioning as accurately as possible). Environmental changes occurring between surveys should also be taken into consideration and compensated for during data processing. For marine seismic surveys, one such environmental change is the variation of seismic wave's propagation velocity in water. For simplicity, the terms “velocity in water” or “water velocity” are used instead of “seismic wave's propagation velocity in water.”

Velocity in water, which is of the order of 1,500 m/s, varies with salinity, temperature, currents' pattern, etc. For example, the article entitled, “Water velocity variations and static corrections in 3D data processing” by Wombell, R. (59^{th} International Meeting: European Association of Geoscience Engineers, A029, 1997, the content of which is incorporated by reference) describes a variation of velocity in water of the order of 10 m/s in seismic data acquired West of Shetland, UK. Such a velocity variation yields time-shifts in wave's travel time through water, as illustrated in FIG. 1.

FIG. 1 illustrates a window of about 100 ms showing (equidistantly arranged) traces after normal move out (NMO) corrections. These traces (e.g., detected pressure amplitude versus time) correspond to base traces extracted from the base data and to monitor traces extracted from monitor data, the base and monitor traces having their mid-point positions within the same bin. It is common practice to group the traces into gathers associated with surface cells called ‘bins’. Each trace is associated with the bin to which the trace's mid-point belongs.

In FIG. 1, the base traces and the monitor traces of a bin are interleaved and ordered depending on the source-receiver offset (i.e., horizontal distance) corresponding to each trace, this offset's magnitude increasing from left to right. Each trace in FIG. 1 has a corresponding point in the band above the window to show whether the trace is a base trace or a monitor trace. If the corresponding point is on the lower edge (B) of the band, the trace is a base trace, and, if the corresponding point is on the upper edge (M) of the band, the trace is a monitor trace.

For each trace, a first reflected seismic wave (see the peaks within stripe F for all the traces) arriving at a receiver carries substantial energy and it is due to the reflection at the seafloor (i.e., a water-solid interface). The NMO correction applied to the base and monitor traces aims to remove the effect of the source-receiver offset, by converting the times along traces into two-way travel times corresponding to the source and the receiver being collocated vertically at the mid-point position. After applying the NMO correction, both the base and the monitor traces corresponding to the same bin should exhibit the same source-receiver travel time to the seafloor, i.e., the NMO corrected times should align along line 110 in FIG. 1.

The NMO correction is applied to both the base and monitor traces using the same velocity in water, i.e., the known base water velocity. However, for some datasets (depending on water depth, oceanographic and meteorological conditions) the monitor water velocity is likely to be different from the base water velocity. This difference causes a time-shift of the NMO-corrected two-way travel-times between base and monitor traces. A time-shift corresponding to any reflector below the seafloor along a trace cumulatively incorporates all the time-shifts above the reflector. Thus, a time-shift at the seafloor due to an inaccurate water velocity is an error that propagates, creating time-shifts for other reflectors along the monitor traces.

As a first guess, the monitor water velocity can simply be considered equal to the base water velocity or to a reference value. In some instances, the water velocity can be measured at the time of the acquisition. However, this approach is not satisfactory because measurements are usually sparse and focus mainly on the superficial layer of water, making it impractical to rely on such direct measurements.

Some conventional techniques for correcting water velocity used for 3D datasets can be applied independently for base data and for monitor data in a 4D data set. However, applying these methods independently for each of the data sets may not be accurate enough for 4D data processing.

Accordingly, it would be desirable to provide methods for taking into account variations in water velocity when processing 4D seismic data, and overcoming the drawbacks of the conventional 4D seismic data processing.

### SUMMARY

In some embodiments, the variation of water velocity in a 4D data set is determined based on analyzing seafloor arrival time-shifts as functions of the source-receiver offset.

According to one embodiment, there is a method for determining a monitor velocity in water related to monitor data of a 4D data set. The method includes extracting monitor traces from the monitor data, and base traces from base data included in the 4D data set, the monitor and the base traces being associated with the same bin. The method further includes selecting pairs of traces so that each pair includes a first trace from the monitor traces and a second trace from the base traces, with traces in a pair belonging to the same offset class. The method then includes determining, for each of the pairs, a time-shift which is a difference of normal move out (NMO) corrected seafloor source-receiver travel times, according to the first trace and according to the second trace, respectively. The method also includes ascertaining the monitor velocity in water by analyzing a relationship between time-shifts of the pairs of traces and corresponding source-receiver offsets.

According to one embodiment, there is a method for determining plural values of a monitor water velocity for monitor seismic data of a 4D data set. The method includes determining values of the monitor water velocity corresponding to bins within a surveyed area, each of the values being ascertained by analyzing a relationship between time-shifts of pairs of traces and source-receiver offsets for a respective one of the bins, wherein each pair of traces includes a first trace extracted from base data of the 4D data set, and a second trace extracted from the monitor data, the first and second trace having offset values within a pre-defined range. The method further includes adjusting the determined values to achieve a smooth spatial variation.

According to another embodiment, there is a method for processing seismic data including receiving a first seismic dataset and information about a first velocity in water related to the first seismic data, and receiving monitor second seismic dataset. The method further includes determining a deviation of a second velocity in water related to the monitor second seismic dataset, from the base first velocity in water, by analyzing a relationship between seafloor time-shifts and source-receiver offsets, using pairs of traces associated with substantially same location, each pair including a trace extracted from the first seismic dataset and a trace extracted from the second seismic dataset, with the traces in a pair having substantially same source-receiver offset.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a graph illustrating traces acquired at the same location in different surveys;

FIG. 2 is a schematic representation of a wave's source-receiver travel path;

FIG. 3 is a flowchart of a method according to an embodiment;

FIG. 4 illustrates base and monitor traces in synthetic data used to test the method according to an embodiment;

FIG. 5 is a graph illustrating dependence of time-shifts on squares of source-receiver offsets in the synthetic data;

FIG. 6 illustrates base and monitor traces in synthetic data after applying the method according to an embodiment;

FIG. 7 is a flowchart of a method for determining values of velocity in water while acquiring monitor seismic data of a 4D data set within a predetermined area, according to another embodiment;

FIG. 8 is a schematic diagram of a dedicated computer according to another embodiment; and

FIG. 9 is a flowchart of a method according to another embodiment.

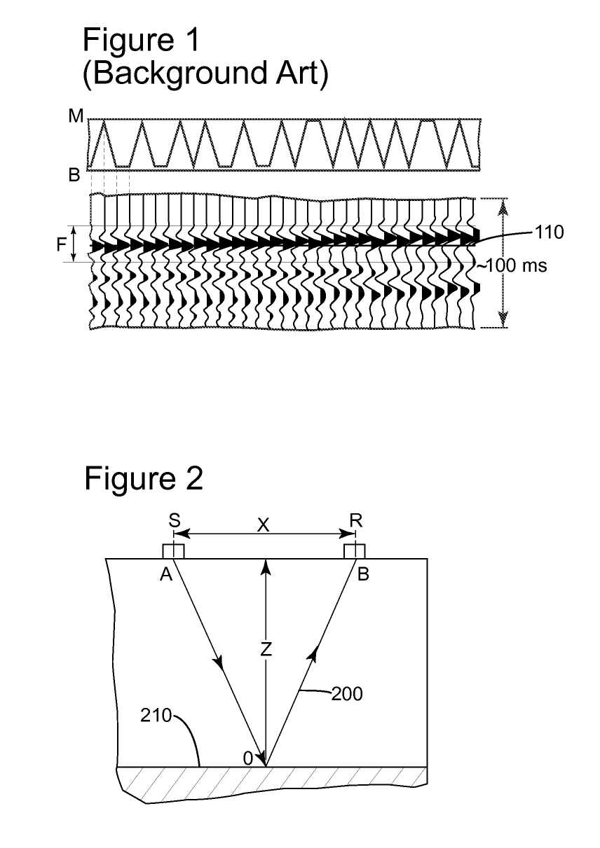

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed with regard to the terminology of 4D marine seismic data analysis. However, the methods related to determining changes in water velocity may also be pertinent in analyzing similar data sets related to electromagnetic waves or other data.

Reference throughout the specification to “one embodiment” or “an embodiment” means that a particular feature, structure or characteristic described in connection with an embodiment is included in at least one embodiment of the subject matter disclosed. Thus, the appearance of phrases “in one embodiment” or “in an embodiment” in various places throughout the specification is not necessarily referring to the same embodiment. Further, the particular features, structures or characteristics may be combined in any suitable manner in one or more embodiments.

According to some embodiments, deviation of the monitor velocity in water relative to the base velocity in water is determined by comparing traces extracted from the monitor data with traces extracted from the base data. More specifically, the monitor velocity in water is determined by analyzing a relationship between time-shifts and source-receiver offsets for pairs of traces selected from base and monitor data in a surface bin. In other words, pairs of traces from two different surveys for a given surface bin (e.g., a seafloor bin or a water surface bin encompassing common-mid-points) are used for calculating the velocity in water for one of the surveys relative to the velocity in water of the other survey. Although the following methods are useful for 4D data, the terms “base” and “monitor” may be mere labels (which may stand, for example, for “reference velocity” and “unknown velocity”) that do not imply a time order or any other acquisition constraints except for the data sets being acquired for the same surveyed area.

FIG. 2 illustrates a source-receiver travel path 200 (i.e., AO+OB) for a wave reflected at the seafloor 210. The water depth is z and a horizontal distance between the source and receiver, known as “source-receiver offset,” is x. If v is the base velocity in water, the detected (e.g., location of a maximum pressure amplitude along the trace) source-receiver travel time of waves reflected at the seafloor for the base data is:

$${t}_{B} = \frac{AO + OB}{v} = \frac{\sqrt{{z}^{2} + {( x \text{/} 2 )}^{2}} + \sqrt{{z}^{2} + {( x \text{/} 2 )}^{2}}}{v} = \sqrt{{( \frac{2 z}{v} )}^{2} + {( \frac{x}{v} )}^{2}} . \qquad ( 1 )$$

Similarly, if v+Δv is the monitor velocity in water (for the same positions A, O and B), the detected source-receiver travel time of waves reflected at the seafloor for the monitor data is:

$${t}_{M} = \frac{AO + OB}{v + Δ v} = \sqrt{{( \frac{2 z}{v + Δ v} )}^{2} + {( \frac{x}{v + Δ v} )}^{2}} . \qquad ( 2 )$$

Customary a NMO correction is applied to the detected source-receiver travel times to remove the effect of source-receiver offset x. For a flat horizontal reflection surface, the detected source-receiver travel time t is:

$${t}^{2} = {t}_{0}^{2} + {( \frac{x}{v} )}^{2} , \qquad ( 3 )$$

where t₀ is travel time when the source and receiver are collocated (i.e., x=0), i.e., a two-way vertical travel time to the seafloor. Thus, the NMO-corrected seafloor source-receiver time is:

$${t}_{0} = \sqrt{{t}^{2} - {( \frac{x}{v} )}^{2}} . \qquad ( 4 )$$

Base water velocity is used to apply NMO correction for both the detected source-receiver travel time t_{B} according to the base trace and the detected source-receiver travel time t_{M} according the monitor trace. After applying formula (4) to t_{B}, the base NMO-corrected source-receiver travel time t_{BO} is:

$${t}_{BO} = \sqrt{{t}_{B}^{2} - {( \frac{x}{v} )}^{2}} = \frac{2 z}{v} . \qquad ( 5 )$$

Upon applying formula (4) to t_{M} using the base velocity v (since the monitor water velocity v+Δv is unknown), the monitor NMO-corrected source-receiver travel time t_{MO} is:

$${t}_{MO} = \sqrt{{t}_{M}^{2} - {( \frac{x}{v} )}^{2}} = \sqrt{{( \frac{2 z}{v + Δ v} )}^{2} + {( \frac{x}{v + Δ v} )}^{2} - {( \frac{x}{v} )}^{2}} . \qquad ( 6 )$$

The time-shift (i.e., time difference) between these NMO-corrected source-receiver travel times for a base and a monitor trace associated to the same bin and pertaining to the same source-receiver offset class (i.e., belonging to a pre-defined offset range) is:

Δt=t_{MO}−t_{BO}. (7)

Note that the time-shift is determined more accurately by cross-correlation between the base and monitor traces than by determining individual travel times along the traces and then calculating their difference.

If Δv/v<<1 (e.g., less than 1%), then Δt for the same source-receiver offset x is:

$$\begin{matrix}Δ t = \sqrt{{( \frac{2 z}{v + Δ v} )}^{2} + {( \frac{x}{v + Δ v} )}^{2} - {( \frac{x}{v} )}^{2}} - \frac{2 z}{v} \\ = \sqrt{{( \frac{2 z}{v} )}^{2} {( 1 + \frac{Δ v}{v} )}^{- 2} + {( \frac{x}{v} )}^{2} {( 1 + \frac{Δ v}{v} )}^{- 2} - {( \frac{x}{v} )}^{2}} - \frac{2 z}{v} .\end{matrix} \qquad ( 8 )$$

Using Taylor expansions and t_{BO}=2z/v, Δt becomes:

$$Δ t = - \frac{Δ v}{v} {t}_{BO} - \frac{Δ v}{{v}^{3} {t}_{BO}} {x}^{2} \qquad ( 9 )$$

Thus, the time-shift which is the difference of NMO-corrected travel times, Δt, can be approximated by a linear function of the square of the source-receiver offset x² for pairs of traces corresponding to the same bin (i.e., same z). Here, each pair includes a first trace extracted from the monitor data, and a second trace extracted from base data, the first and second traces corresponding to the same source-receiver offset (x). The slope of a linear fit of Δt versus x² is proportional to the difference, Δv, between monitor water velocity and base water velocity. Time-shift Δt is determined with high accuracy by cross-correlation between the base and monitor traces in the same pair. In other embodiments, other methods of determining the time-shift may be used.

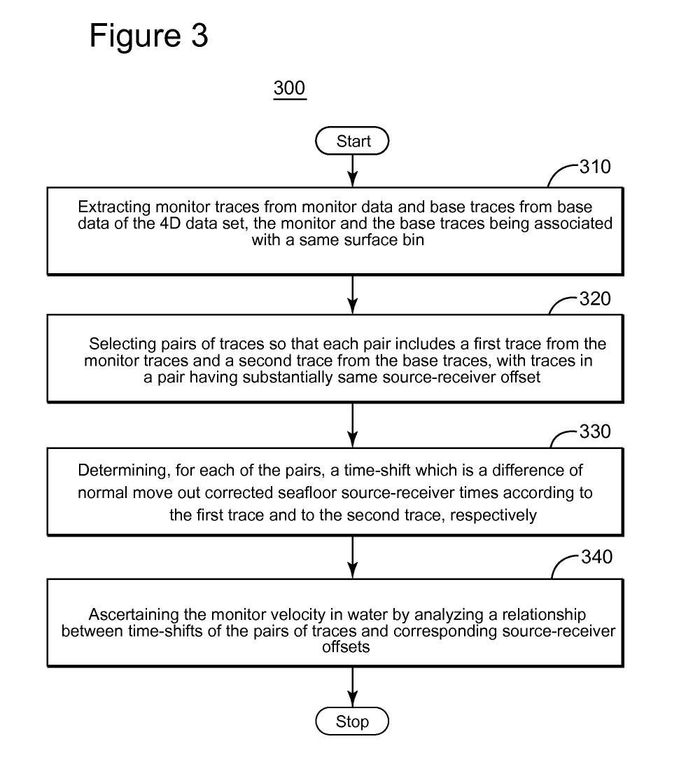

FIG. 3 is a flowchart of a method 300 for determining a monitor velocity in water relative to the base velocity in water. Although method 300 is described to refer to base data and monitor data, it should be understood that “base” and “monitor” are used to distinguish the two sets of data and are not intended to be limiting. In particular, “base” data does not have to correspond to the first in time among the surveys in the 4D data set, but simply to a reference dataset. Similarly, “monitor” data refers to data not used as a reference.

Method 300 includes extracting monitor traces from the monitor data, and base traces from base data of the 4D data set, at 310. The extracted monitor and the base traces are associated with the same surface bin (i.e., a seafloor bin, a water surface bin for traces' midpoints, or other bin as known in the art), and, thus they have substantially the same depth.

Method 300 further includes, at 320, selecting pairs of traces so that each pair includes a first trace from the monitor traces and a second trace from the base traces with traces in a pair belonging to the same offset class (i.e., their source-receiver offsets are within a pre-defined range). For example, acquired data may be grouped in offset ‘bins’, which are called offset classes (e.g., traces in a first offset class could have offsets between 100 and 199 m, traces in a second offset class could have offsets between 200 and 299 m, etc.). Preferably, the selected traces have source-receiver offsets such that a difference between a minimum and a maximum source-receiver offset to exceed a predetermined threshold, and the source-receiver offset values to cover all the minimum-maximum range (i.e., the source-receiver offset values are not grouped in a narrow vicinity, but include various different source-receiver offset values) in order to be able to reliably ascertain the relationship.

Method 300 then includes determining, for each of the selected pairs, a time-shift corresponding to waves reflected at the seafloor, at 330. The time-shift is a difference of NMO-corrected seafloor source-receiver travel times, for the first trace and for the second trace, respectively. The time-shift may be determined using a cross-correlation between the relevant portions of the first and second traces. However, other known techniques for determining the time-shift may be employed.

Method 300 then includes ascertaining the monitor velocity in water by analyzing a relationship between time-shifts of the pairs of traces and corresponding source-receiver offsets, at 340.

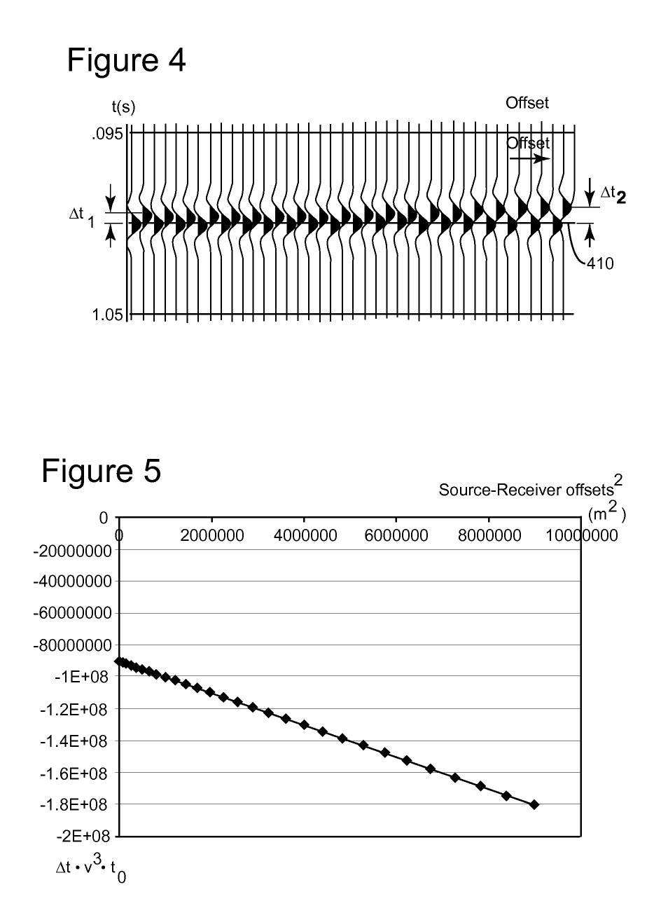

The above method 300 has been applied to synthetic data simulating a base seismic survey performed while base velocity is 1,500 m/s, and a monitor seismic survey performed while monitor velocity is 1,510 m/s. FIG. 4 illustrates interleaved NMO-corrected traces extracted from base and monitor data, corresponding to increasing (from left to right) source-receiver offset, for the same surface bin. NMO correction for both base and monitor traces was applied using the base velocity in water. In FIG. 4, no additional indication regarding whether a trace is base or monitor is necessary because the base (B) traces and the monitor (M) traces alternate (i.e., BMBM . . . ).

Thus, FIG. 4 illustrates a window of about 100 ms (i.e., 0.1 s) along the traces. The base traces' seafloor arrival times are aligned along a reference line 410. As the source-receiver offset increases (from left to right), the monitor traces' seafloor times depart more and more from reference line 410. Thus, a time shift Δt₁ between base and monitor traces corresponding to a smaller source-receiver offset illustrated on the left portion of FIG. 4 is smaller than a time shift Δt₂ between base and monitor traces corresponding to a larger source-receiver offset illustrated on the right portion of FIG. 4.

FIG. 5 is a graph of (i) the time-shifts Δt multiplied with the cube (i.e., third power) of base water velocity v (i.e., 1,500 m/s) and with the base NMO-corrected source-receiver travel time t_{BO}, versus (ii) corresponding squares of source-receiver offsets (x²).

Returning now to formula (9), by multiplying it with v³t_{BO}, one obtains:

$$Δ {tv}^{3} {t}_{BO} = - \frac{Δ v}{v} {v}^{3} {t}_{BO}^{2} - \frac{Δ v}{v} \frac{{x}^{2}}{{v}^{2} {t}_{BO}} {v}^{3} {t}_{BO}^{2} = - Δ v \cdot {v}^{2} {t}_{BO}^{2} - Δ v \cdot {x}^{2} \\ y = A - Δ v \cdot {x}^{2} \qquad ( 10 )$$

where y=Δtv³t_{BO} and A=−Δv·v²t_{BO}².

Thus, if y versus x² (as illustrated in FIG. 5) is fitted with a straight line, the slope of the line is −Δv. For the synthetic data generated for a 10 m/s increase of the monitor water velocity relative to the base water velocity of 1,500 m/s, the slope value obtained using an embodiment of the above-described method was −Δv=−9.99 m/s.

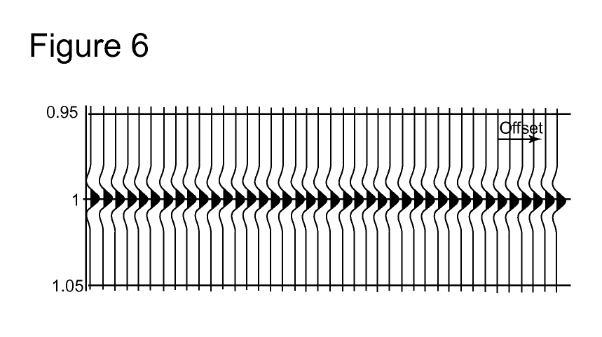

A water layer replacement may then be performed using the monitor water velocity, for example, as described in the article “Correcting for water column variations” by C. Lacombe et al., published in “The leading Edge” in February 2009, the content of which is incorporated by reference. FIG. 6 illustrates base traces from FIG. 4 interleaved with monitor traces from FIG. 4 after applying water layer replacement using monitor water velocity. In FIG. 6, no differences (time-shifts) can be observed between the base traces and the monitor traces, with all seafloor source-receiver travel times aligning to the same reference line.

Method 300 focuses on a single surface bin. The method may be applied individually to all bins in a surveyed area since velocity in water may vary from sail-line to sail-line or even along a sail-line.

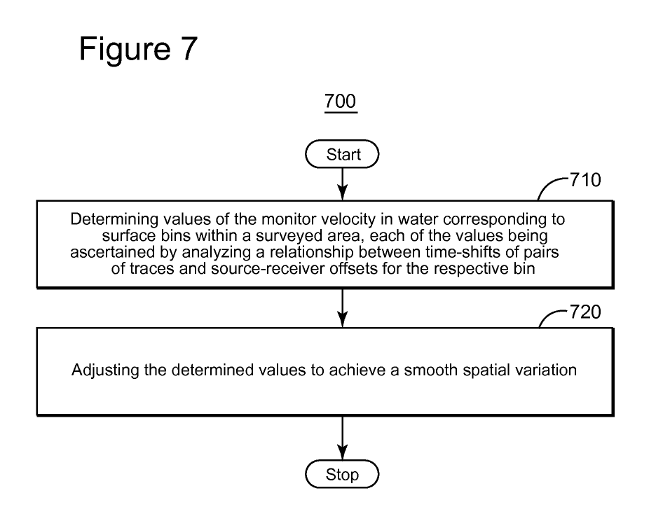

FIG. 7 is a flowchart of a method 700 for determining plural values of a monitor water velocity related to monitor seismic data of a 4D data set. Method 700 includes determining values of the monitor water velocity corresponding to each surface bin within a surveyed area, at 710. Each of the plural values of the monitor water velocity is ascertained by analyzing a relation between time-shifts of pair of traces and source-receiver offsets for a respective one of the surface bins. Each time-shift is determined from a pair of traces, which correspond to the surface bin and a same source-receiver offset (i.e., the traces belong to the same source-receiver class). A first trace of the pair is extracted from base data and a second trace of the pair is extracted from monitor data. Effective implementation of step 710 may be similar to method 300 or alternative embodiments previously discussed.

Further, method 700 includes adjusting the determined values to achieve their smooth spatial variation, at 720. This adjusting may be performed along a sail-line (i.e., a line along which the data acquisition system has been towed). The adjusting may include replacing a value of the monitor velocity exceeding neighboring values with a likely value of the monitor water velocity (e.g., a running median or average). In one embodiment, the likely value is a weighted average of the neighboring values along the sail-line. Here, the weights may depend on a distance between the neighbor bin and the currently considered bin.

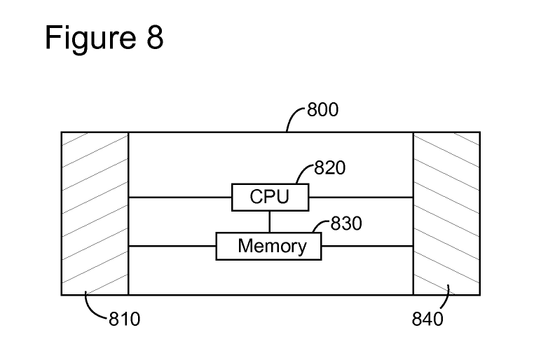

The above-described methods may be implemented as computer programs (i.e., executable codes) non-transitorily stored on a computer-readable storage medium. The methods may be executed on a dedicated computer 800 as illustrated in FIG. 8. Computer 800 includes an input/output interface 810 configured to facilitate communication of seismic data and user commands. Computer 800 further includes a data processing unit 820 configured to determine monitor velocity by analyzing seafloor time-shifts' dependence on source-receiver offsets in pairs of traces extracted from the monitor data and reference (e.g., base) data included in the 4D data set. Computer 800 may also include a memory 830 configured to store the 4D data set before and after applying the methods. Memory 830 may also store computer-executable codes for executing the methods according to various embodiments. Computer 800 may also include a display 840 configured to display images generated using data such as in FIGS. 4-6.

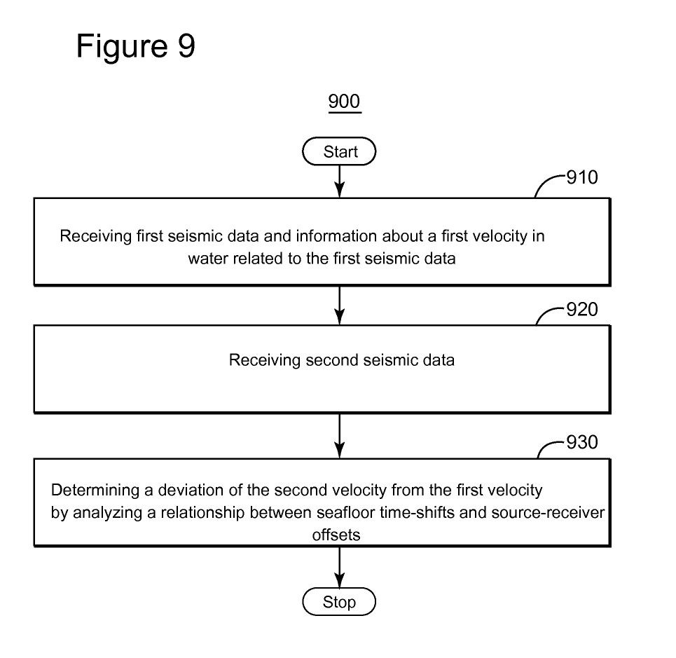

A flowchart of a method 900 that may be performed by the dedicated computer 800 is illustrated in FIG. 9. Method 900 includes receiving base a first seismic dataset and information about its velocity in water, at 910. Method 900 further includes receiving a second seismic dataset, at 920. The first and second seismic datasets may have been acquired using the same data acquisition system including various seismic sources and streamers. However, within a time range of months or even years between successive surveys, the equipment improves, becomes more accurate, and capable to acquire seismic data having a higher density. For example, the later surveys may be performed with variable-depth profile streamers and with multi-level seismic sources. Before a typical pre-processing of the seismic data to extract differences between traces, the seismic data may be converted to harmonize the first dataset and the second datasets to enable their comparison without loss of new information.

Method 900 then includes determining a deviation of the velocity in water by analyzing a relationship between seafloor time-shifts and corresponding source-receiver offsets, using pairs of traces associated with substantially same location (e.g., in a same surface bin), at 930. Each pair includes a trace extracted from the first seismic dataset and a trace extracted from the second seismic dataset, with the traces having substantially same source-receiver offset. Having substantially same source-receiver offset means that the traces are in a source-receiver class so that their individual deviation from an average value associated with the class does not impact significantly this method.

The above methods eliminate the errors due to direct picking of the seafloor arrival time in the conventional methods.

The disclosed embodiments provide methods for avoiding errors caused by variation of the seismic wave propagation velocity in water while processing a 4D data set. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of exemplary embodiments, numerous specific details are set forth in order to provide a comprehensive understanding of the claimed invention. However, one skilled in the art would understand that various embodiments may be practiced without such specific details.

Although the features and elements of the present exemplary embodiments are described in particular combinations, each feature or element may be usable alone without the other features and elements of the embodiments or in other various combinations with or without other features and elements disclosed herein.

The written description uses examples of the subject matter disclosed to enable any person skilled in the art to practice the same, including making and using the described devices or systems and performing any of the described methods. The patentable scope of the subject matter is defined by the claims, and may include other examples that occur to those skilled in the art. Such examples are intended to be within the scope of the claims.

What is claimed is:

1. A method for determining a monitor velocity in water related to monitor data of a 4D data set, the method comprising:
extracting monitor traces from the monitor data, and base traces from base data included in the 4D data set, the monitor and the base traces being associated with a same surface bin;
selecting pairs of traces so that each pair includes a first trace from the monitor traces and a second trace from the base traces, with traces in a pair belonging to the same offset class;
determining, for each of the pairs, a time-shift which is a difference of normal move out (NMO) corrected seafloor source-receiver travel times, according to the first trace and according to the second trace, respectively; and
ascertaining the monitor velocity in water by analyzing a relationship between time-shifts of the pairs of traces and corresponding source-receiver offsets.

2. The method of claim 1, wherein the time-shift is determined using a cross-correlation between the first trace and the second trace.

3. The method of claim 1, wherein
the relationship is obtained by fitting a straight line on a graph of the time-shifts of the pairs versus squares of the source-receiver offsets, and
a deviation of the monitor velocity in water from a base velocity in water associated with the base data is calculated based on a slope of the straight line.

4. The method of claim 3, wherein the deviation is Δv=−mv³t₀, where m is the slope of the straight line, v is the base velocity in water and t₀ is a two-way vertical seafloor travel time.

5. The method of claim 4, wherein the two-way vertical seafloor travel time is calculated using an average of the NMO-corrected seafloor source-receiver travel times for the base traces.

6. The method of claim 1, wherein, before the determining of the time-shift, an NMO correction is applied to the first trace and to the second trace using a base velocity in water associated with the base data.

7. The method of claim 1, wherein the same surface bin is a seafloor bin or a water-surface bin that includes trace mid-points.

8. The method of claim 1, further comprising:
performing a water layer replacement using the monitor velocity in water.

9. A method for determining plural values of a monitor water velocity for monitor seismic data of a 4D data set, the method comprising:
determining values of the monitor water velocity corresponding to surface bins within a surveyed area, each of the values being ascertained by analyzing a relationship between time-shifts of pairs of traces and source-receiver offsets for a respective one of the surface bins, wherein each pair of traces includes a first trace extracted from base data of the 4D data set, and a second trace extracted from the monitor data, the first and second trace having substantially same source-receiver offset; and
adjusting the determined values to achieve a smooth spatial variation.

10. The method of claim 9, wherein following steps are performed for determining one of the respective values associated with one of the surface bins:
extracting monitor traces from the monitor data, and base traces from the base data, the monitor and the base traces being associated with the respective one of the surface bins;
selecting pairs of traces spanning a predetermined range of source-offsets;
determining the time-shift for each of the selected pairs as a difference of normal move out (NMO) corrected seafloor source-receiver travel times, according to the first trace and according to the second trace, respectively; and
fitting a straight line on a graph of the time-shifts of the pairs of traces versus squares of corresponding source-receiver offsets.

11. The method of claim 9, wherein, before determining a time-shift of any of the pairs, an NMO correction is applied to the first trace and to the second trace using a base velocity in water associated with the base data.

12. The method of claim 9, wherein the adjusting includes replacing a value of the monitor water velocity that exceeds neighboring values with more than a predetermined amount, with a likely value thereof.

13. The method of claim 12, wherein the likely value is inferred based on the neighboring values along a sail-line.

14. The method of claim 13, wherein the likely value of the monitor velocity is a weighted average of the neighboring values along the sail-line.

15. A method for processing seismic data, comprising:
receiving first seismic dataset and information about a first velocity in water related to the first seismic data;
receiving second seismic dataset; and
determining a deviation of a second velocity in water related to the second seismic dataset, from the first velocity in water, by analyzing a relationship between seafloor time-shifts and source-receiver offsets, using pairs of traces associated with substantially same location, each pair including a trace extracted from the first dataset and a trace extracted from the second dataset, with the traces in a pair having substantially same source-receiver offset.

16. The method of claim 15, wherein
the relationship is determined by fitting a straight line on a graph of the time-shifts versus squares of the source-receiver offsets, and
the deviation is calculated based on a slope of the straight line.

17. The method of claim 16, wherein the deviation is Δv=−mv³t₀, where m is the slope of the straight line, v is the base velocity in water at the seafloor location and t₀ is a two-way vertical seafloor travel time to the seafloor.

18. The method of claim 16, wherein the two-way vertical seafloor travel time is calculated using an average of the NMO-corrected source-receiver travel times for traces of the first dataset.

19. The method of claim 15, wherein, before calculating a time-shift an NMO correction is applied to the first trace and to the second trace using the first velocity in water associated with the seafloor location according to the information.

20. The method of claim 15, further comprising:
performing a water layer replacement for the second dataset using the second velocity.
